(19) United States
(12) Patent Application Publication
(10) Pub. No.: US 2026/0194635 A1
(43) Pub. Date: Jul. 9, 2026

(54) PHOTONIC LANTERN FOR ALIGNMENT-INSENSITIVE TEMPORALLY DISPERSED LIDAR

(71) Applicant: The Government of the United States as represented by the Secretary of the Air Force, Wright-Patterson AFB, OH (US)

(72) Inventors: Christian Keyser, Milton, FL (US); Trevor Courtney, Niceville, FL (US); Rodrigo Amezcua-Correa, Orlando, FL (US); Stephanos Yerolatsitis, Orlando, FL (US); Caleb Dobias, Apopka, FL (US)

(21) Appl. No.: 19/077,407

(22) Filed: Mar. 12, 2025

Related U.S. Application Data
(60) Provisional application No. 63/742,979, filed on Jan. 8, 2025.

(51) Int. Cl. G01S 7/481; G01J 3/02; G01S 7/484; G01S 7/486; G01S 7/4865

(52) U.S. Cl. CPC G01S 7/4818; G01J 3/0218; G01S 7/484; G01S 7/4865; G01S 7/4868

(57) ABSTRACT

A LiDAR system includes a laser for delivering a beam pulse comprised of multiple wavelengths that is directed toward and reflected off a target, a dispersive optic for receiving and temporally dispersing wavelengths within the beam pulse, and only one single-pixel sensor for receiving the beam pulse after it has been temporally dispersed and measuring and outputting separate intensity values for the different wavelengths in the beam pulse. The dispersive optic includes a first photonic lantern, a second photonic lantern downstream of the first photonic lantern, and a plurality of single-mode fibers connecting the first and second photon lanterns. At least one of the first photonic lantern, the second photonic lantern, and the plurality of single-mode fibers is configured to provide chromic induced delays and/or fiber-length delays on the different wavelengths in the beam pulse to obtain the desired temporal dispersion consistent with the specific spectral LiDAR spectrum.

### CROSS-REFERENCE TO RELATED APPLICATIONS

Pursuant to 37 C.F.R. § 1.78(a)(4), this application claims the benefit of and priority to prior filed co-pending Provisional Application Ser. No. 63/742,979, filed Jan. 8, 2025, which is expressly incorporated herein by reference in its entirety.

### RIGHTS OF THE GOVERNMENT

The invention described herein may be manufactured and used by or for the Government of the United States for all governmental purposes without the payment of any royalty.

### FIELD OF THE INVENTION

The present invention relates generally to LiDAR systems and, more particularly, to multidimensional and alignment-sensitive LiDAR systems.

### BACKGROUND OF THE INVENTION

In order to reduce cost, size, weight, and power (CSWAP) of multidimensional light detection and ranging (LiDAR) systems, it is attractive to replace conventional spatially multiplexed systems (best shown in FIG. 1) with temporally multiplexed systems (best shown in FIG. 2) For example, a spectral LiDAR may collect the multi-wavelength optical signal from the target and couple the light into a single-mode (SM) fiber so that the SM fiber chromatic dispersion causes a wavelength-dependent time delay. The spectral information is separated in time such that the relative location in time indicates the wavelengths. In contrast to a traditional spectrometer-based system employing a grating and a detector array, temporally separated spectral features can be measured by a single detector resulting in lower CSWAP.

A practical challenge to this approach of coupling the light to a SMF is that the SMF has small core (~8 um) and numerical aperture (NA) (~0.14) making alignment stability vs. temperature variation, vibration, and shock nearly impossible. Multi-mode (MM) fibers initially appear to be an attractive alternative because their large core size and NA have relaxed spatial and angular alignment tolerances, respectively. However, they have modal dispersion that can broaden the pulse associated with each spectral feature reducing signal to noise ratio (SNR) of individual spectral features. Additionally, there is limited control in engineering the chromatic delay. The chromatic delay introduced by the fiber should be chosen so that the zero-dispersion point is outside of the region spanned by the laser spectrum. In this example, the spectrum spans 1.06-1.7 um so the ZDSG with zero dispersion point near 1600 nm is better optimized to ensure the spectrum is spread in time and does not fold back onto itself.

Accordingly, there is a need for a LiDAR system that provides the relaxed alignment tolerances associated with MM fibers but provides the well-defined and tailorable dispersion associated with SMF.

### SUMMARY OF THE INVENTION

The present invention overcomes at least one of the foregoing problems and other shortcomings, drawbacks, and challenges of existing multidimensional light detection and ranging (LiDAR) systems. While the invention will be described in connection with certain embodiments, it will be understood that the invention is not limited to these embodiments. To the contrary, this invention includes all alternatives, modifications, and equivalents as may be included within the spirit and scope of the present invention.

According to one embodiment of the present invention, a LiDAR system comprises a laser for delivering a beam pulse comprising multiple wavelengths that is directed toward and reflected off a target, a dispersive optic for receiving the beam pulse and temporally dispersing different wavelengths within the beam pulse, and only one single-pixel sensor for receiving the beam pulse after it has been temporally dispersed and measuring and outputting separate intensity values for the different wavelengths in the beam pulse. The dispersive optic comprises a first photonic lantern having a single multi-mode (MM) input and a plurality of single-mode (SM) outputs, and a second photonic lantern downstream from the first photonic lantern and having a plurality of SM inputs and a single MM output.

According to another embodiment of the present invention, a LiDAR system comprises a transmitter and a receiver. The transmitter comprises laser for delivering an original beam pulse comprising multiple wavelengths, and output optics for directing the original beam pulse as an incident beam pulse onto a target, the incident beam pulse thereby reflecting from the target as a reflected beam pulse. The receiver, comprises a dispersive optic for temporally dispersing the different wavelengths in the reflected beam pulse, and thereby producing a dispersed beam pulse, only one single-pixel sensor for receiving the dispersed beam pulse and measuring and outputting separate intensity values for the wavelengths in the dispersed beam pulse, and a processor for receiving the intensity values, correlating the intensity values with the wavelengths, comparing the intensity values to known intensity values for the wavelengths in the incident beam pulse, and producing reflectance data in regard to the target from the comparison. The dispersive optic comprises a first photonic lantern having a single MM input and a plurality of SM outputs, and a second photonic lantern downstream of the first photonic lantern and having a plurality of SM inputs and a single MM output.

According to yet another embodiment of the invention, a LiDAR system comprises a transmitter and a receiver. The transmitter comprises a laser for delivering an original beam pulse comprised of multiple wavelengths, and output optics for directing the original beam pulse as an incident beam pulse onto a target, the incident beam pulse thereby reflecting from the target as a reflected beam pulse. The receiver comprises a dispersive optic for temporally dispersing the discrete wavelengths in the reflected beam pulse, and thereby producing a dispersed beam pulse, only one single-pixel sensor for receiving the dispersed beam pulse and measuring and outputting separate intensity values for the wavelengths in the dispersed beam pulse, and a processor for receiving the intensity values, correlating the intensity values with the wavelengths, comparing the intensity values to known intensity values for the wavelengths in the incident beam pulse, and producing reflectance data in regard to the target from the comparison. The dispersive optic comprises a first photonic lantern having a single MM input and a plurality of SM outputs, and a second photonic lantern downstream of the first photonic lantern and having a plurality of SM inputs and a single MM output;

Additional objects, advantages, and novel features of the invention will be set forth in part in the description which follows, and in part will become apparent to those skilled in the art upon examination of the following or may be learned by practice of the invention. The objects and advantages of the invention may be realized and attained by means of the instrumentalities and combinations particularly pointed out in the appended claims.

### BRIEF DESCRIPTION OF THE DRAWINGS

The accompanying drawings, which are incorporated in and constitute a part of this specification, illustrate embodiments of the present invention and, together with a general description of the invention given above, and the detailed description of the embodiments given below, serve to explain the principles of the present invention.

FIG. 1 is a graph showing intensity versus wavelength for a conventional spatially-dispersed spectrometer.

FIG. 2 is a graph showing normalized intensity versus time (ns) for a temporally dispersed spectrometer.

FIG. 3A is schematic first end view of a first type of photonic lantern.

FIG. 3B is schematic side view of the first type of photonic lantern.

FIG. 3C is schematic second end view of the first type of photonic lantern.

FIG. 4A is schematic first end view of a second type of photonic lantern.

FIG. 4B is schematic side view of the second type of photonic lantern.

FIG. 4C is schematic second end view of the second type of photonic lantern.

FIG. 5A is schematic first end view of a third type of photonic lantern.

FIG. 5B is schematic side view of the third type of photonic lantern.

FIG. 5C is schematic second end view of the third type of photonic lantern.

FIG. 6 is a functional block diagram of a LiDAR system according to a first embodiment of the present invention.

FIG. 7 is a functional block diagram of a LiDAR system according to a second embodiment of the present invention.

FIG. 8 is a functional block diagram of a LiDAR system according to a third embodiment of the present invention.

FIG. 9 is a functional block diagram of a LiDAR system according to a fourth embodiment of the present invention.

FIG. 10 is a schematic view of an embodiment of the temporal dispersive optics of FIGS. 6 to 9.

FIG. 10A is a schematic view of another embodiment of the temporal dispersive optics of FIGS. 6 to 9.

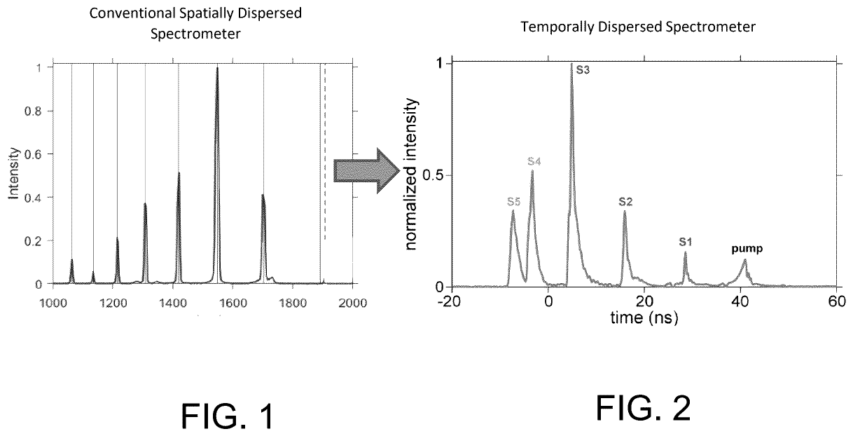

It should be understood that the appended drawings are not necessarily to scale, presenting a somewhat simplified representation of various features illustrative of the basic principles of the invention. The specific design features of the sequence of operations as disclosed herein, including, for example, specific dimensions, orientations, locations, and shapes of various illustrated components, will be determined in part by the particular intended application and use environment. Certain features of the illustrated embodiments have been enlarged or distorted relative to others to facilitate visualization and clear understanding. In particular, thin features may be thickened, for example, for clarity or illustration.

### DETAILED DESCRIPTION OF THE INVENTION

The following examples illustrate particular properties and advantages of some of embodiments of the present invention. Furthermore, these are examples of reduction to practice of the present invention and confirmation that the principles described in the present invention are therefore valid but should not be construed as in any way limiting the scope of the invention.

The present invention utilizes at least one photonic lantern (PL) that provides relaxed alignment tolerances associated with multi-mode (MM) fiber and can interface single-mode (SM) fiber. SM fiber operations can then be performed on the incident light. For example, the SM fiber can be tailored to provide well-defined dispersion. The PL is a photonic device that forms an interface between a MM waveguide and a plurality of SM waveguides and allows a low-loss transition from one to other as required by the function of the optical system under consideration. Most generally, a PL includes a plurality of SM waveguides at one end (the SM end) that are interfaced to a MM waveguide at the other end (the MM end) through a physical waveguide transition.

In a standard fiber-based PL, an array or bundle of SM fibers is placed inside a secondary cladding, of lower index than both the cores and cladding of each of the MM and the SM fibers. The transition involves the cores of the SM fibers reducing in size and losing their ability to confine the light. The light thus spreads to the cladding, and becomes confined by the lower index secondary cladding, which have now become core and cladding of the final MM fiber waveguide, respectively.

A PL can be manufactured by making a physical transition in which the SM waveguides either stop acting as such, and/or cease behaving as independent uncoupled waveguides. This physical transition also adiabatically forms a MM waveguide in which the SM waveguides either vanish or form a composite waveguide formed by strong coupling between them.

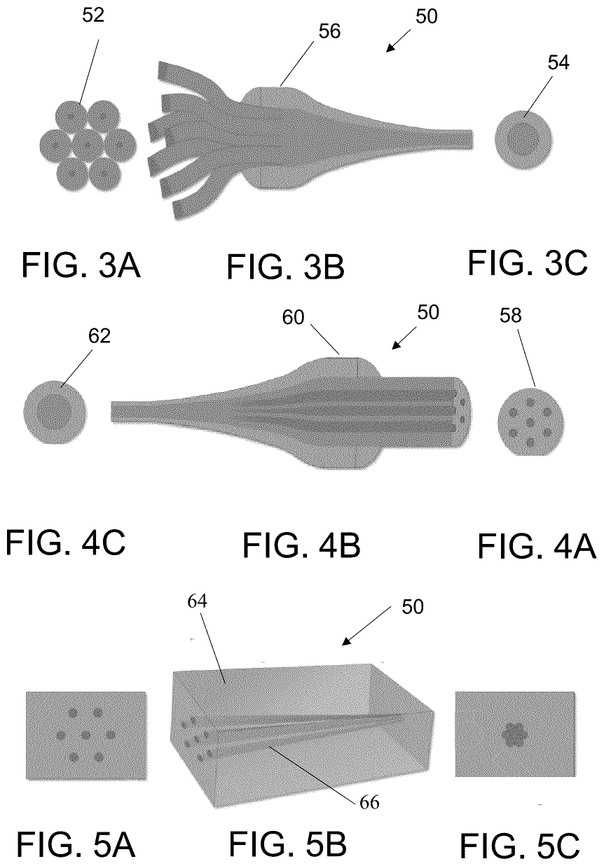

A PL 50 can be manufactured by at least three different methods. As best shown in FIGS. 3A to 3C, the first illustrated method is an all-solid optical fiber splitter/combiner fabrication technique. The PL 50 is manufactured by first inserting a bundle or array of SM fibers 52 into a first end of a low-index glass capillary tube which is then fused and tapered down in a glass processing machine to form an all-solid MM fiber 54 at the other end. The low-index glass of the capillary tube forms a low-refractive-index jacket 56.

As best shown in FIGS. 4A to 4C, the second illustrated method uses optical fibers to manufacture the PL 50 including a multi-core fiber 58 and a bundle or array of identical SM cores. The PL 50 is manufactured by tapering the multi-core fiber 58, while, placing a low-refractive-index jacket 60 around the SM cores to form the cladding of the MM fiber 62.

As best shown in FIGS. 5A to 5C, the third illustrated method uses ultrafast laser writing techniques to form the PL 50. Laser writing is used to form waveguide cores 66 in a piece of bulk glass 64. The laser illumination causes an increase in the refractive index, which forms the waveguide core, and the technique allows for positioning of these cores in three-dimensions within the bulk glass. In this case, the isolated SM waveguide cores are created and gradually brought together such as they couple strongly. This creates the adiabatic optical transition required for the SM to multimode conversion, and the strongly coupled cores form the final multimode composite waveguide.

Each of the illustrated manufacturing methods has its advantages and disadvantages. For more information see “Photonic lanterns”, S. G. Leon-Saval, Nanophotonics 2013; 2(5-6): 429-440, published by De Gruyter Nov. 8, 2013, the disclosure of which is incorporated herein in its entirety by reference. It is noted that any other suitable form of PL 50 can alternatively be utilized.

The present invention utilizes PLs configured to provide relaxed alignment tolerances associated with MM fiber, and SM fibers to provide well-defined and tailorable dispersion associated with SM fiber. For example, but not limited to, a first PL having one MM input and N SM output, a second PL having N SM input and one MM output, and N SM fibers connecting the SM output of the first PL with the SM input of the second PL, and a single detector coupled to the MM output of the second PL.

The first PL separates the MM facet input light into the SM fibers according to the modal content of the light. The greater the MM nature of the input light, that is, the greater the misalignment, the larger the quantity of the N SM outputs that are required to collect and separate the light into individual modes. Note that the MM input of the first PL has a larger fiber collection aperture and thus looser alignment tolerances. By interfacing the MM light to the N SM fiber, SM fiber operations can be done on the incident light within the N SM fibers. Thus, the N SM fibers between the first and second PLs can be adapted introduce delays to obtain the desired dispersion profile and/or to add additional functionality. For example, the N SM fibers can be adapted to provide different chromic delays, can be adapted to have different lengths, and/or can be adapted in any other suitable manner to obtain the desired dispersion profile.

In one embodiment, a Lidar optical signal is directed into the MM input of a first PL, and in the presence of misalignment, the optical signal is separated into the N SM cores. Each SM core carries the spectral information associated with one of the modes of the light incident on the first PL. Now, with the spectral signature being separated into N SM cores, the light can be directed into to N SM fibers to introduce suitable delays. These N SM fibers can be either be in the form of N individual SM fibers or a single fiber with N SM cores. The individual fibers/cores can be tailored to provide the desired dispersion consistent with the spectral LiDAR spectrum. Lastly, the N SM cores are connected to a second PL that reunites the separate optical signals into the MM output with the desired dispersion profile that can be couped to a single optical detector as described in more detail hereinbelow.

This technique can be extended to temporally multiplexing other optical features in support of polarimetric LiDAR, coherent detection, etc. For example, but not limited to, for coherent detection, where after coupling into the first PL and separation into the N SM fiber, each SM fiber is directed through different length SMF to introduce a mode dependent temporal delay. Then the N SM fiber of different length can be recombined with a second PL and directed to a single detector. Mixing the stream of different mode coherent light with a local oscillator signal will allow a single detector to measure the full signal received at the first PL.

Various embodiments of the present invention are described below. Of course, these disclosed embodiments are just a sampling of all of the possible embodiments of the present invention. Each disclosed embodiment includes a LiDAR system that directs multiple wavelengths of radiation onto a target and reflects those wavelengths according to the properties of the target. The wavelengths are temporally dispersed, either before or after being reflected from the target, and just one single-pixel sensor reads the intensities of the temporally dispersed wavelengths in the order that they are received. In this manner, only one single-pixel sensor is needed to separately measure the intensities of the reflected wavelengths.

In various embodiments, the laser that produces the original beam can take different forms. The wavelengths can be produced in different ways. Filters can optionally be used in different places to remove some of the wavelengths. Different structures can be used to temporally disperse the wavelengths, and those structures can be in different locations.

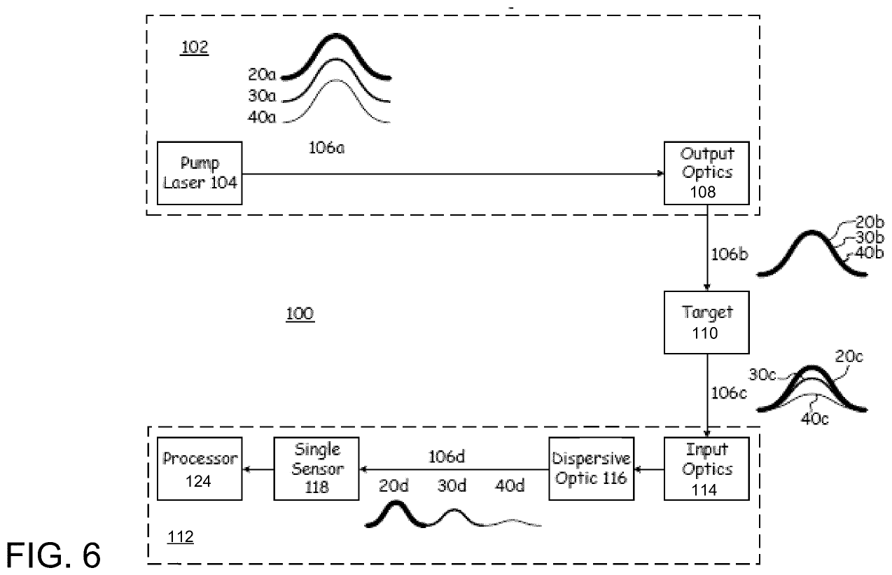

In the embodiment depicted in FIG. 6, a LiDAR system 100 includes a transmitter 102 with a pump laser 104. The pump laser 104 pumps a nonlinear element such as, for example but not limited to, a fiber, optical crystal, and the like to produce a multispectral laser which can be a supercontinuum laser, cascaded Raman source, and the like. The multispectral laser creates an original beam pulse 106a having, for example, spectral components or wavelengths 20a, 30a, and 40a.

Output optics 108 receive the original beam pulse 106a and direct an incident beam pulse 106b toward a target 110, which scatters the incident beam pulse 106b into a reflected beam pulse 106c. A receiver 112 captures portions of the reflected beam pulse 106c with input optics 114 that pass the reflected beam pulse 106c along to a dispersive optic 116.

The dispersive optic 116 temporally disperses the wavelengths of the reflected beam pulse 106c (spreads different wavelengths out over time), and thereby produces a temporally dispersed beam pulse 106d, which is directed to just one single-pixel sensor 118. The single-pixel sensor 118 measures the intensity of the dispersed beam pulse 106d versus time, which yields reflectivity information in regard to the reflectivity of the target 110 at each of the wavelengths in the reflected beam pulse 106c.

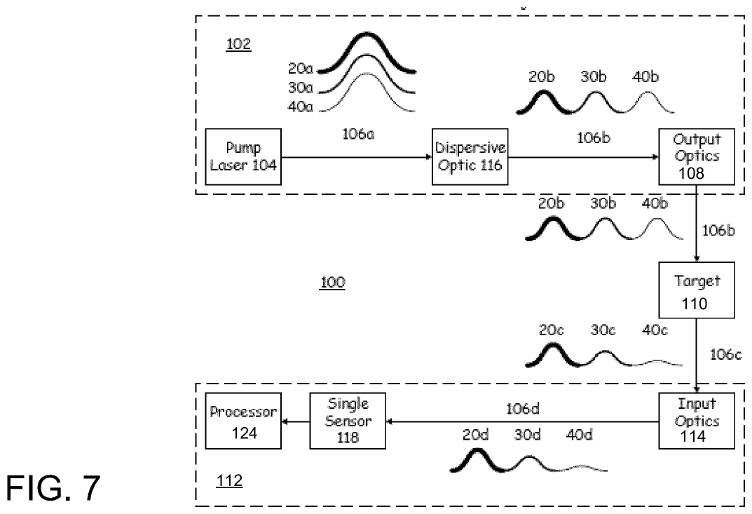

In the embodiment depicted in FIG. 7, the dispersive optic 116 is disposed in the transmitter 102 between the pump laser 104 and the output optics 108 rather than in the receiver 112 between the input optics 114 and the single sensor 118.

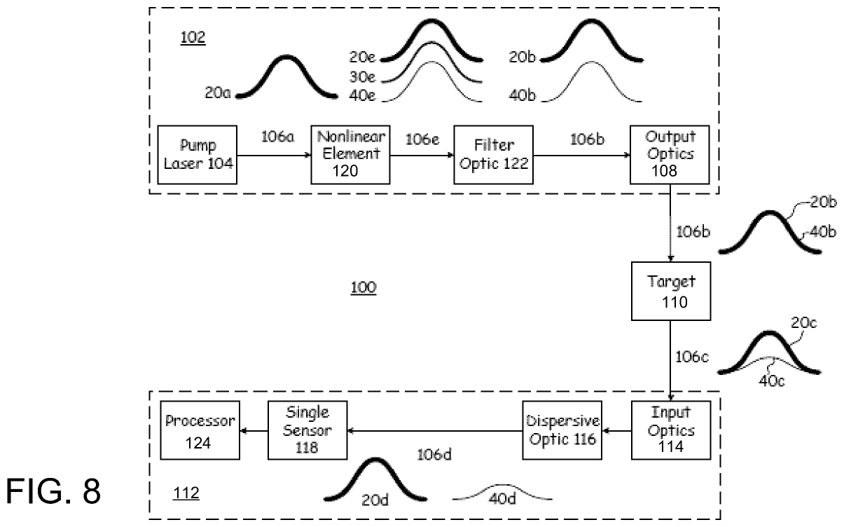

In the embodiment depicted in FIG. 8, the pump laser 104 is a monochromatic laser that produces a single wavelength (such as 20a) in the original beam pulse 106a, and a nonlinear element 120 produces different wavelengths 20e, 30e, and 40e in the beam 106e, which represent either multispectral components of the beam 106e, or a supercontinuum of wavelengths. In some embodiments, the nonlinear element or optic 120 is at least one of a gas-filled, hollow core, photonic-crystal Raman fiber, a solid core, photonic crystal Raman fiber, or the like.

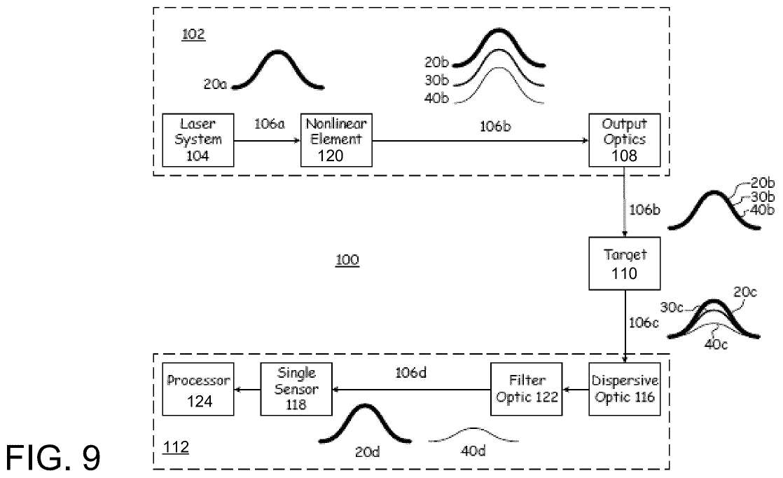

In some embodiments, one or more of the beam pulses 106 is received by a filter optic 122, which filters the beam pulse 106 that it receives so that a lesser number of wavelengths are passed. In the embodiment depicted in FIG. 8, the filter optic 122 is disposed at the output of the nonlinear element 120 and passes only a subset of the received wavelengths of the beam pulse 106e. In the embodiment depicted in FIG. 9, the filter optic 122 is disposed within the receiver 112 after the dispersive optic 116.

One purpose of the filter optic 122 is to create or widen a spectral space between the wavelengths that are present in the beam pulse 106 that is received by the filter optic 122. Thus, it is appreciated that the filter optic 122 can be placed in many other locations than just those as depicted in the figures. Additionally, it should be appreciated that the filter optic 122 can be utilized in any embodiment.

Sometimes the wavelengths 20, 30, and 40 are depicted in the figures as spread out vertically. This indicates that the associated beam pulse 106 includes more than one wavelength, the number of which may be more or less than what is depicted in the figures. In this representation, the x-axis generally represents time.

This depiction of the vertical spacing is used for clarity in the description and is not intended to be any kind of literal depiction of how a multispectral beam appears. Similarly, different line weights are used for the different wavelengths 20, 30, and 40 in the figures. Again, this is so that it is easier to see that there are different wavelengths in the beam pulse 106, such as wavelengths 20, 30, and 40.

Sometimes, a beam pulse 106 is depicted with all of the wavelengths 20, 30, and 40 on top of each other. For those beam pulses 106 where the temporal dispersion of the beam pulse 106 has been performed, the wavelengths 20, 30, and 40 are spread out horizontally. These various depictions of the beam pulse 106 are used for greater clarity at the point in the figures at which they are used. In summary, vertical spreading is meant to imply that there is more than one wavelength. Horizontal spreading is meant to imply temporal dispersion of the wavelengths.

When the incident beam pulse 106b impinges upon the target 110, portions of the wavelengths 20, 30, and 40 are absorbed to some varying degree by the target 110, and portions of the wavelengths 20, 30, and 40 are reflected and scattered by the target 110, to produce the reflected beam pulse 106c. Depending upon the properties of the target 110, some wavelengths will be absorbed more than other wavelengths. This is represented in the figures by reducing to some degree the height of a given wavelength 20, 30, or 40, such as in the beam pulse 106c.

For example, in the embodiment depicted in FIG. 9, wavelength 20—depicted as the fattest line—is substantially 100% scattered by the target 110, which means that the target 110 did not absorb a significant portion of the wavelength 20. In actual implementation, it would be somewhat rare that a target 110 would reflect substantially 100% of an incident wavelength, but that example is used in this embodiment so as to more clearly see the distinctions between the reflectivity of the various wavelengths 20, 30, and 40.

Also as depicted in FIG. 9, wavelength 30—depicted as the medium weight line-is absorbed by the target 110 to some intermediate degree, and so a lesser portion of the wavelength 30 is scattered by the target 110. Finally, wavelength 40—depicted as the lightest weight line—is absorbed to a greater degree than the other two wavelengths 20 and 30, and so an even lesser portion of the wavelength 20 is scattered by the target 110.

These variations in the absorption and reflection of the target 110 at different wavelengths is manifested in intensity peaks that are reduced by some different amount for each wavelength, when comparing the reflected beam pulse 106c to the incident beam pulse 106b.

The one single-pixel sensor 118 in the receiver 112, as introduced above, cannot discriminate between one wavelength and another. All of the wavelengths 20c, 30c, and 40 would appear the same to the single-pixel sensor 118, which merely registers changes in intensity over the measured time duration of the reflected beam pulse 106c. Thus, if the reflected beam pulse 106c were to be directed to the single-pixel sensor 118 without any modification, the single-pixel sensor 118 would merely read the cumulative intensity of the reflected beam pulse 106c, without any way to determine the individual and varying contributions of the various component wavelengths 20c, 30c, or 40c.

Therefore, the beam pulse 106 is, at some point prior to the single-pixel sensor 118, received by the dispersive optic 116, which temporally distributes (spreads out in time) the wavelengths 20, 30, and 40 of the beam pulse 106.

The result is that each of the wavelengths 20, 30, and 40 in a dispersed beam pulse 106 are offset one from another, and in some embodiments (such as those in which a filter optic 122 is employed) are separated by some relatively small amount of time. By relatively small, it is meant that the amount of time by which the wavelengths 20, 30, and 40 are separated is not so great as to be confused with the length of time between consecutive pulses of the pump laser 104.

Thus, the one single-pixel sensor 118 is able to detect the difference between consecutive pulses. In other words, the last-received wavelength (such as 40d in the embodiment as depicted) is received significantly closer in time to the preceding discrete wavelength 30d, then it is to the first-received wavelength 20d of the next beam pulse. Thus, the one single-pixel sensor 118 is able to determine temporally dispersed pulses one from another, even though the wavelengths 20, 30, and 40 are temporally dispersed.

The amplitude signals for each wavelength 20d, 30d, and 40d are sent from the single-pixel sensor 118 to a processor 124, which is then able to identify which peak is which by the order in which it is received in a given pulse. Thus, just one single-pixel sensor 118 is able to provide information about the reflectivity of the target 110, because the processor 124 has data that identifies the discrete wavelengths 20, 30, and 40 by the order in which the single-pixel sensor 118 sends the signal information. Thus, the various embodiments of the present invention do not need a linear array of sensor elements, or a two-dimensional array of sensor elements, such as are typically employed with spatially distributed methods and apparatuses.

The wavelength-specific amplitude values from the dispersed beam pulse 106d are compared to the amplitude of each of the wavelength-specific amplitude values from the incident beam pulse 106b, and the degree of reflectance and absorption of the target 110 can then be calculated, such as by the processor 124, which in some embodiments uses range and calibration information as well. This reflectance or absorption information is then used, such as by the processor 124 or another device, to determine certain properties of the target 110, using methods that are presently understood in the art.

For example, the degree of reflectance by a given wavelength 20, 30, or 40 from the target 110 can be determined by comparing the intensity of the given wavelength 20a, 30a, or 40a in the incident beam pulse 106b—which is either empirically known or can be determined from the operating parameters of the transmitter 102—to the measured 10 amplitude of the associated wavelength 20c, 30c, or 40c as sensed by the single-pixel sensor 118 from the dispersed beam pulse 106d. In some embodiments, these functions are performed by the processor 124.

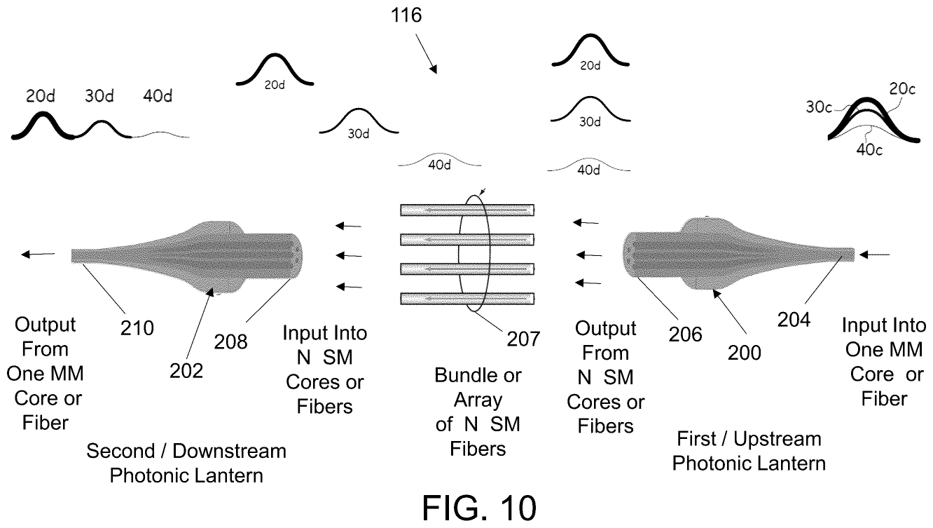

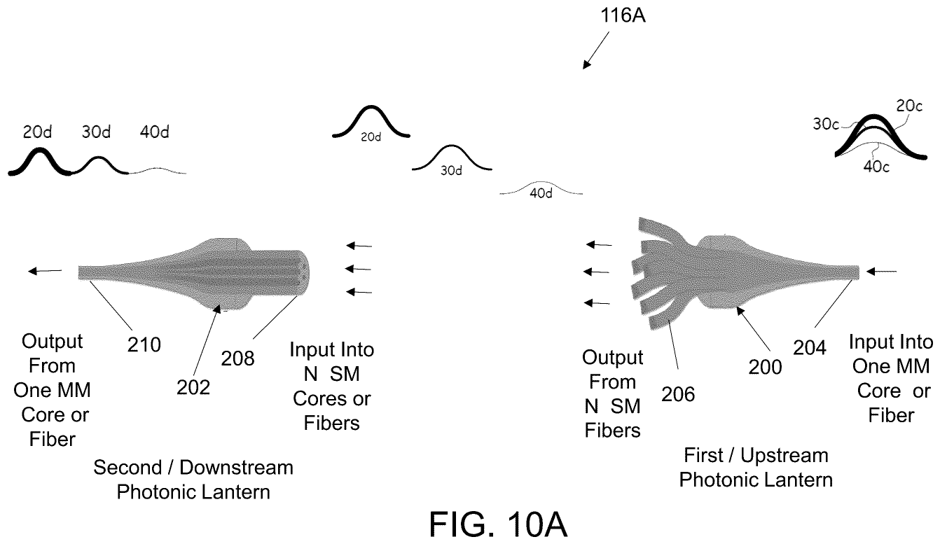

FIG. 10 illustrates an embodiment of the dispersive optic 116 that temporally disperses the wavelengths of the reflected beam pulse 106c in the illustrated embodiments of FIGS. 6, 8, and 9, and the beam pulse 106a in the illustrated embodiment of FIG. 7. The illustrated embodiment of the dispersive optic 116 includes a first or upstream PL 200, a second or downstream PL 202, and a plurality of N SM fibers 207 connecting the first PL 200 to the second PL 202.

The illustrated first or upstream PL 200 is a 1×N PL. The illustrated first or upstream end of the first PL 200 has one MM input 204. The illustrated MM input 204 is configured to receive the reflected beam pulse 106c or the beam pulse 106a depending on the location of the dispersive optic 116. The illustrated second or downstream end has N SM outputs 206. Each of the illustrated N SM outputs 206 is designed to carry a specific mode of the light. In the illustrated embodiment, N is greater than one and equal to the number of individual modes of the multi-mode light 106c or 106a. The first PL 200 is configured to separate the multi-mode light 106c or 106a into its individual modes, with each mode carried by a particular one of the N SM outputs 206. The greater the multi-mode nature of the input light pulses 106c or 106a, or the greater the misalignment, the larger quantity of the N SM outputs 206 that are required to collect and separate the input light into individual modes.

The MM input 204 of the first PL 200 allows a larger fiber collection aperture and looser alignment tolerances. The illustrated N SM outputs 206 of the first PL 200 are connected to the second or downstream PL 202 which is then coupled to the single-pixel sensor 118. In the illustrated embodiment, the N SM outputs 206 of the first PL 200 are connected to the N SM inputs 208 of the second PL 202 by a bundle or array of N SM fibers. These N SM fibers 207 can be either be in the form of N individual SM fibers or a single fiber with N SM cores. It is noted that any other suitable intermediary or intermediaries can be alternately or additionally positioned between the first PL 200 and the second PL 202 if desired.

The illustrated second or downstream PL 202 is a N×1 PL. The illustrated first or upstream end of the second PL 202 has N SM inputs 208. The N SM inputs 208 are configured to receive the separate modes of light from the first PL 200. The illustrated N SM inputs 208 of the second PL 202 are connected to the N outputs 206 of the first PL 200 via the N SM fibers 207. Each of the illustrated N SM inputs 208 is designed to carry a specific mode of the light. In the illustrated embodiment, N is equal to the N of the N SM outputs of the first PL 200 and the N SM fibers 207. The illustrated second or downstream end of the second PL 202 has one MM output 210. The second PL 202 is configured to receive N separate single-modes of light and combine that N separate single-modes of light back into to multi-mode light. The illustrated MM output 210 is coupled to the to the single-pixel sensor 118. It is noted that the illustrated embodiment of the dispersive optic 116 can alternatively have any other suitable configuration.

In one embodiment, the dispersive optic 116 passes smaller wavelengths more slowly, and so the largest wavelength in the reflected beam pulse is output first from the dispersive optic 116, and then the next highest wavelength in the reflected beam pulse 106c is output from the dispersive optic 116, and so forth until all of the discrete wavelengths 20c, 30c, and 40c in the reflected beam pulse 106c have been output one at a time from the dispersive optic 116 in the manner as depicted in dispersed beam pulse 106d. It is noted that the wavelengths can alternatively be dispersed in any other suitable order if desired.

In the illustrated embodiment, each of the N SM fibers 207 connecting the N SM outputs 206 of the first PL 200 to the N SM inputs 208 of the second PL 202 carries the spectral information associated with one of the modes of the light incident on the MM input 204 of the first PL 200. Any one or more of these N SM fibers 207 can be configured to provide chromic induced delays. Alternately or additionally, any one or more of these N SM fibers 207 can be configured to provide fiber-length induced delays by suitably varying the lengths of the N SM fibers 207. Thus, the bundle or array of N SM fiber 207 can be tailored to provide the desired dispersion consistent with the specific spectral LiDAR spectrum.

Thus, each wavelength 20d, 30d, and 40d in a given dispersed beam pulse 106d is eventually received by the lone single-pixel sensor 118 at a different point in time, without confounding by any of the other wavelengths 20d, 30d, and 40d in the dispersed beam pulse 106d. In this manner, the order in which a given wavelength is received identifies which wavelength is being received. Thus, the intensity of each wavelength 20d, 30d, and 40d in the dispersed beam pulse 106d is independently measured and associated with the proper wavelength. Therefore, the reflectivity at each wavelength 20, 30, and 40 can be directly measured by comparing the known intensity of the wavelength 20b, 30b, and 40b in the incident beam pulse 106b (which is known) with the measured intensity of the wavelength 20d, 30d, and 40d in the dispersed beam pulse 106d.

FIG. 10A illustrates another embodiment of the dispersive optic 116A according to the present invention. In this embodiment, the first PL 200 and/or the second PL 202 are configured to provide the delay so that the dispersive optic 116A outputs all of the discrete wavelengths 20c, 30c, and 40c in the reflected beam pulse 106c one at a time like described above in the previous embodiment. Essentially, the dispersion functions of the bundle or array of N SM fibers 207 are incorporated into the first PL 200 and/or the second PL 202. Thus, the bundle or array of N SM fibers 207 can be eliminated if desired so that the first and second PLs 200, 202 are directly connected. In the illustrated embodiment, the delays are produced by providing different lengths to the individual N SM outputs 206 of the first PL 200. The lengths can be tailored to provide the desired dispersion consistent with the specific spectral LiDAR spectrum. It is noted that alternatively a combination of chromic induced delay and fiber-length induced delay can be utilized if desired. It is also noted that the second PL 202 can be provided with N SM input fibers 208 to alternately or additionally provide desired chromic induced delay and fiber-length induced delay

Each N SM output cores/fibers 206 and each N SM input cores/fibers 208 carries the spectral information associated with one of the modes of the light incident on the MM input 204 of the first PL 200. Any one or more of these N SM cores/fibers 206, 208 can be configured to provide chromic induced delays and any one or more of these N SM cores/fibers 206, 208 can be configured to provide fiber length induced delays. Thus, the individual first and second PLs 200, 202 can be tailored to provide the desired chromic dispersion consistent with the specific spectral LiDAR spectrum.

In those embodiments that use a supercontinuum laser 104, the associated serial continuum in the beam pulse 106 would tend to cause ambiguity in discriminating one wavelength 20, 30, and 40 from another when they are passed to and measured by the single-pixel sensor 118. This can be remedied by use of a filter optic 122 that blocks certain wavelengths, such as 30, so as to place gaps into the temporal continuum of the beam pulse 106, such as at known wavelengths, which in the example depicted, results in discrete wavelengths 20 and 40 in the beam pulse 106. In one embodiment, the filter optic 122 is a Fabry-Perot filter or a dielectric filter, which blocks multiple wavelength bands.

In some embodiments where there are many more than three wavelengths used, the filter optic 122 filters out wavelengths such that a single discrete wavelength is not immediately temporally abutted by any other single discrete wavelength. In this manner, when the single-pixel sensor 118 detects an input signal, it can be determined by the processor 124 which discrete wavelength that signal belongs to, because the order of the wavelengths is known, and the wavelengths that are passed by the filter optic 122 are known.

In any of these embodiments, the processor 124 is able to determine which of the signals from the single-pixel sensor 118 belongs to which of the discrete wavelengths 20, 30, and 40, because the order of the discrete wavelengths 20, 30, and 40 as received by the single-pixel sensor 118 is known. Further, in some embodiments the processor 124 compares the amplitude of each discrete wavelength signal as measured by the single-pixel sensor 118 to the amplitude of each corresponding wavelength in the incident beam pulse 106b, which is know either through empirical study or from the known operating parameters of the transmitter 102.

These two amplitudes for each discrete wavelength 20, 30, and 40 are compared, such as by taking ratios of the amplitudes as the reflectivity is given by incident to reflected signals one from another and quantifying the difference, to determine how much the target 110 has diminished the amplitude of each discrete wavelength 20, 30, and 40. This diminishing of the amplitude is accounted to the absorption properties of the target 110 at each of the discrete wavelengths 20, 30, and 40. This information is then used in ways that are known in the art to determine certain properties in the regard to the target 110.

Thus, embodiments according to the present invention replace heavier, larger, and more expensive parts, such as gratings and multi-pixel sensor arrays, with a nonlinear element 120, dispersive optic 116, 116A, and a single-pixel sensor 118, which are generally lighter, smaller, and less expensive than the parts that they are replacing. This is an important benefit for technologies such as machine vision for missiles and autonomous vehicles.

The foregoing description of embodiments for this invention has been presented for purposes of illustration and description. It is not intended to be exhaustive or to limit the invention to the precise form disclosed. Obvious modifications or variations are possible in light of the above teachings. The embodiments are chosen and described in an effort to provide illustrations of the principles of the invention and its practical application, and to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

The phrase “and/or” as used in this specification should be understood to mean “either or both” of the elements being referred to, i.e., elements that are conjunctively present in some instances and disjunctively present in other instances. Other elements may optionally be present other than the elements specifically identified by the “and/or” clause, whether related or unrelated to those elements specifically identified unless clearly indicated to the contrary.

As used in this specification, the term “preferably” refers to one or more exemplary embodiments of the invention and therefore is not to be interpreted in any limiting sense.

The terms “comprises,” “comprising,” “includes,” “including,” “has,” “having,” or any other variations thereof used herein, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

Reference to “one embodiment,” “certain embodiments,” “an embodiment,” “implementation(s),” “aspect(s),” or similar terms used herein means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means “any of the following: A; B; C; A and B; A and C; B and C; A, B and C.” An exception to this definition will occur only when a combination of elements, functions, steps or acts are in some way inherently mutually exclusive. Also, grammatical conjunctions are intended to express any and all disjunctive and conjunctive combinations of conjoined clauses, sentences, words, and the like, unless otherwise stated or clear from the context. Thus, the term “or” should generally be understood to mean “and/or” and so forth.

It will be understood that terms of orientation and/or position as may be used throughout the specification and claims, such as upper, lower, rear, side, forward, downward, upward, inner, and so on, as well as their derivatives and equivalent terms, relate to relative rather than absolute orientations and/or positions.

All patents, patent applications (and any patents which issue thereon, as well as any corresponding published foreign patent applications), publications, and other documents mentioned throughout this description are hereby incorporated by reference herein. It is expressly not admitted, however, that any of the documents incorporated by reference herein teach or disclose the present invention.

The words “about,” “approximately,” or the like, when accompanying a numerical value, are to be construed as indicating a deviation as would be appreciated by one of ordinary skill in the art to operate satisfactorily for an intended purpose.

It should be understood that every maximum numerical limitation used herein includes every lower numerical limitation, as if such lower numerical limitations were expressly written herein. Every minimum numerical limitation used herein includes every higher numerical limitation, as if such higher numerical limitations were expressly written herein. Every numerical range herein includes every narrower numerical range that falls within such broader numerical range, as if such narrower numerical ranges were all expressly written herein.

For simplicity and clarity of illustration, reference numerals may be repeated among the figures to indicate corresponding or analogous elements. Numerous details are set forth to provide an understanding of the embodiments described herein. The embodiments may be practiced without these details. In other instances, well-known methods, procedures, and components have not been described in detail to avoid obscuring the embodiments described. The description is not to be considered as limited to the scope of the embodiments described herein.

References herein to items in the singular should be understood to include items in the plural, and vice versa, unless explicitly stated otherwise or clear from the text.

While the present invention has been illustrated by a description of one or more embodiments thereof and while these embodiments have been described in considerable detail, they are not intended to restrict or in any way limit the scope of the appended claims to such detail. Additional advantages and modifications will readily appear to those skilled in the art. The invention in its broader aspects is therefore not limited to the specific details, representative apparatus and method, and illustrative examples shown and described.

Accordingly, departures may be made from such details without departing from the scope of the general inventive concept.

What is claimed is:

1. A LiDAR system, comprising:
a laser for delivering a beam pulse comprised of multiple wavelengths that is directed toward and reflected off a target, a dispersive optic for receiving the beam pulse and temporally dispersing different wavelengths within the beam pulse;
wherein the dispersive optic comprises a first photonic lantern having a single multi-mode input and a plurality of single-mode outputs, and a second photonic lantern downstream from the first photonic lantern and having a plurality of single-mode inputs and a single multi-mode output; and
only one single-pixel sensor for receiving the beam pulse after it has been temporally dispersed and measuring and outputting separate intensity values for the different wavelengths in the beam pulse.

2. The LiDAR system of claim 1, further comprising a processor for receiving the intensity values, correlating the intensity values with the wavelengths, comparing the intensity values to known intensity values for the wavelengths in the beam pulse before it is reflected by the target, and producing reflectance data in regard to the target from the comparison.

3. The LiDAR system of claim 1, further comprising a plurality of single-mode fibers connecting the plurality of single-mode outputs of the first photonic lantern to the plurality of single-mode inputs of the second photonic lantern.

4. The LiDAR system of claim 3, wherein the plurality of single-mode fibers is configured to temporally disperse the different wavelengths within the beam pulse.

5. The LiDAR system of claim 1, wherein at least one of the first and second photonic lanterns is configured to temporally disperse the different wavelengths within the beam pulse.

6. The LiDAR system of claim 5, wherein any one or more of the plurality of single-mode outputs of the first photonic lantern and/or any one or more of the plurality of single-mode inputs of the second photonic lantern are configured to provide chromic induced delays and/or fiber length delays.

7. The LiDAR system of claim 1, wherein the plurality of single-mode outputs of the first photonic lantern is N single-mode output fibers.

8. The LiDAR system of claim 1, wherein the plurality of single-mode inputs of the second photonic lantern is N single-mode input fibers.

9. The LiDAR system of claim 1, wherein the laser and the dispersive optic are disposed in a transmitter, and the dispersive optic disperses the wavelengths before the beam pulse is reflected by the target.

10. The LiDAR system of claim 1, wherein the dispersive optic and the one single-pixel sensor are disposed in a receiver, and the dispersive optic disperses the wavelengths after the beam pulse is reflected by the target.

11. A LiDAR system comprising:
a transmitter, comprising:
laser for delivering an original beam pulse comprised of multiple wavelengths; and
output optics for directing the original beam pulse an incident beam pulse onto a target, the incident beam pulse thereby reflecting from the target as a reflected beam pulse; and
a receiver, comprising:
a dispersive optic for temporally dispersing the different wavelengths in the reflected beam pulse, and thereby producing a dispersed beam pulse;
wherein the dispersive optic comprises a first photonic lantern having a single multi-mode input and a plurality of single-mode outputs, and a second photonic lantern downstream of the first photonic lantern and having a plurality of single-mode inputs and a single multi-mode output; and
only one single-pixel sensor for receiving the dispersed beam pulse and measuring and outputting separate intensity values for the wavelengths in the dispersed beam pulse; and
a processor for receiving the intensity values, correlating the intensity values with the wavelengths, comparing the intensity values to known intensity values for the wavelengths in the incident beam pulse, and producing reflectance data in regard to the target from the comparison.

12. The LiDAR system of claim 11, further comprising a plurality of SM fibers connecting the plurality of single-mode outputs of the first photonic lantern to the plurality of single-mode inputs of the second photonic lantern.

13. The LiDAR system of claim 12, wherein the plurality of single-mode fibers is configured to temporally disperse the different wavelengths within the beam pulse.

14. The LiDAR system of claim 11, wherein at least one of the first and second photonic lanterns is configured to temporally disperse the different wavelengths within the beam pulse.

15. The LiDAR system of claim 14, wherein any one or more of the plurality of single-mode outputs of the first photonic lantern and/or any one or more of the plurality of single-mode inputs of the second photonic lantern are configured to provide chromic induced delays and/or fiber length delays.

16. The LiDAR system of claim 11, wherein the dispersive optic and the one single-pixel sensor are disposed in a receiver, and the dispersive optic disperses the different wavelengths after the beam pulse is reflected by the target.

17. A LiDAR system, comprising:
a transmitter, comprising:
a laser for delivering an original beam pulse comprised of multiple wavelengths, and
output optics for directing the original beam pulse as an incident beam pulse onto a target, the incident beam pulse thereby reflecting from the target as a reflected beam pulse, and
a receiver, comprising:
a dispersive optic for temporally dispersing the discrete wavelengths in the reflected beam pulse, and thereby producing a dispersed beam pulse;
wherein the dispersive optic comprises a first photonic lantern having a single multi-mode input and a plurality of single-mode outputs, and a second photonic lantern downstream of the first photonic lantern and having a plurality of single-mode inputs and a single multi-mode output;
only one single-pixel sensor for receiving the dispersed beam pulse and measuring and outputting separate intensity values for the wavelengths in the dispersed beam pulse; and
a processor for receiving the intensity values, correlating the intensity values with the wavelengths, comparing the intensity values to known intensity values for the wavelengths in the incident beam pulse, and producing reflectance data in regard to the target from the comparison.

18. The LiDAR system of claim 17, further comprising a plurality of single-mode fibers connecting the plurality of single-mode outputs of the first photonic lantern to the plurality of single-mode inputs of the second photonic lantern.

19. The LiDAR system of claim 18, wherein the plurality of single-mode fibers is configured to temporally disperse the different wavelengths within the beam pulse.

20. The LiDAR system of claim 17, wherein at least one of the first and second photonic lanterns is configured to temporally disperse the different wavelengths within the beam pulse.
